(19) United States
(12) Patent Application Publication
(10) Pub. No.: US 2017/0270974 A1
(43) Pub. Date: Sep. 21, 2017

(54) Method for Controlling Multimedia and Electronic Device

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yin LI, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/242,321

(22) Filed: Aug. 19, 2016

Related U.S. Application Data
(63) Continuation of application No. PCT/CN2016/088486, filed on Jul. 4, 2016.

(30) Foreign Application Priority Data
Mar. 21, 2016 (CN) 201610161982.1

(51) Int. Cl. G11B 27/11; G11B 19/20

(52) U.S. Cl. CPC G11B 27/11; G11B 19/20

(57) ABSTRACT

The present disclosure provides a method for controlling multimedia and electronic device, the method includes: configuring a target area and multimedia content to be played in the target area; detecting whether a current geographic location is located in the target area or not; controlling the multimedia device to be turned on, and controlling the multimedia device to start playing the multimedia content when the current geographic location is located in the target area; and controlling the multimedia device to be turned off when the current geographic location is located outside of the target area.

### CROSS-REFERENCE TO RELATED APPLICATIONS

The present application is the continuous application of the PCT application PCT/CN2016/088486, filed on Jul. 4, 2016. The present disclosure claims priority to the Chinese Patent Application No. 201610161982.1 filed with the Patent Office of the People's Republic of China on Mar. 21, 2016, the entire contents of all of which are incorporated herein by reference.

### TECHNICAL FIELD

The present disclosure relates to the technical field of computers, and more particularly to a method for controlling multimedia and electronic device.

### BACKGROUND

The current user may kill the time by watching multimedia content on a journey or at a certain place in leisure time, for example, the user watches multimedia content on a journey from home to the company, watches multimedia content on a vehicle-mounted rear seat screen when taking a taxi, or watches multimedia content when arriving at a certain specified WIFI hotspot and so on.

However, every time the user needs to click the screen manually so as to choose to start playing the multimedia content when wanting to watch the multimedia content, and needs to click the screen manually so as to stop playing the multimedia content when not wanting to watch the multimedia content. In this way, the operation process of the user is complicated and time-consuming. Moreover, under the condition that the multimedia content is played by the vehicle-mounted screen on the taxi, the screen is always in normally-on state because the operation which the driver needs to manually turn on or turn off the screen for each time is cumbersome, thereby the electric energy is consumed.

### SUMMARY

In order to overcome the problems in the related art, the present disclosure provides a method for controlling multimedia and electronic device.

According to the first aspect of the embodiment of the present disclosure, the embodiment of the present disclosure provides a method for controlling multimedia, including:

configuring a target area and multimedia content to be played in the target area;

detecting whether a current geographic location is located in the target area or not;

controlling a multimedia device to be turned on, and controlling a multimedia device to start playing the multimedia content when the current geographic location is located in the target area; and

controlling the multimedia device to be turned off when the current geographic location is located outside of the target area.

According to the second aspect of the embodiment of the present disclosure, the embodiments of the present disclosure further provide a nonvolatile computer storage media, which stores computer-executable instructions for executing any one of the methods for controlling multimedia of the present disclosure.

According to the third aspect of the embodiment of the present disclosure, the embodiments of the present disclosure further provide an electronic device, which includes: one or more processor; and a memory; wherein the memory stores instructions that are executable by the one or more processor, and the instructions are configured to execute any one of the method for controlling multimedia aforementioned of the present disclosure.

### BRIEF DESCRIPTION OF THE DRAWINGS

In order to more clearly illustrate the technical solutions of the embodiments of the present disclosure or of the prior art, the drawings needed to be used in the description of the embodiments or the prior art will be briefly introduced below. Apparently, those of ordinary skill in the art can also obtain other drawings according to these drawings without creative effort.

FIG. 1 is a flow chart of a method for controlling multimedia illustrated according to an exemplary embodiment.

FIG. 2 is a structure chart of a device for controlling multimedia illustrated according to an exemplary embodiment;

FIG. 3 is a diagram of the hardware configuration of the electronic device which is further provided by the embodiments of the present disclosure to execute the method for controlling multimedia.

### DETAILED DESCRIPTION

The exemplary embodiments are illustrated in detail here, the examples of which are shown in the drawings. When the description below relates to the drawings, the same number in the different drawings represents the same or similar element unless otherwise expressed. The implementation ways described in the exemplary embodiments below do not represent all the implementation ways consistent with the present disclosure. On the contrary, the implementation ways are merely examples of the devices and methods consistent with some aspects of the present disclosure and described in detail in the attached claims.

At present, a normal user watches multimedia content such as some videos and MVs etc. on a short journey between the company and home for each time or in the leisure time after going back home for each time. The normal user needs to stop watching the multimedia content when leaving the short journey between the company and home or leaving home. However, when needing to start or stop watching the multimedia content for each time, the user needs to manually turn on or turn off the corresponding multimedia applications. The manual operation process is very cumbersome and time-consuming, therefore, as shown in FIG. 1, in an embodiment of the present disclosure, a method for controlling multimedia is provided and applied to terminals. The terminals may refer to mobile phones, tablet computers and vehicle-mounted terminals and so on. The method includes the following steps.

In the step S101, a target area and multimedia content to be played in the target area are configured.

In the embodiments of the present disclosure, the target area may be a path composed of a plurality of journeys, and may also be an area of a regular shape or an area of irregular shape and so on taking a geographic location as its center. The multimedia content may be regarded as video content and audio content etc.

Before the step S101, the user can set an access right in advance whether a GPS positioning module of the terminal may be permitted to be used during the video playing control process or not. Of course, in order to accurately determine the current geographic position of the user, the access right of the GPS positioning module needs to be opened. Moreover, the user may configure the location and the range of the area and the multimedia content to be played in the area etc. For example, the location of the area may be a home address, a frequently-visited coffee house address, or may be a longitude and a latitude of the home address and the longitude and the latitude of the coffee house address, and further may be places between home and the company where the user takes a taxi etc. The range can be determined by the WIFI signal range and the position error range etc. For example, the range can be set as 10m and so on when the home address is taken as its center, and the range of the places between home and the company where the user takes a taxi may be 3m etc. Then the location and the range of the area as well as the multimedia content configured by the user are stored in a predetermined storage space.

In the step S102, whether a current geographic location is located in the target area or not is detected.

Before the step S102, the current geographic location of the terminal can be detected by the GPS positioning module in the terminal.

In the step S102, the detected current geographic location may be compared with the location and range of the target area. When the current geographic location is located within the range of the target area, it may be determined that the current geographic location is located in the target area. For example, when the current geographic location is located within the range of 10m where the home address is taken as its center, it may be determined that the current geographic location is located in the target area. For another example, when the current geographic location is located within the range of 3 m from the bus stop address near the company, or within the range of 3 m from each point of the path between the bus stop near the company and home, or within the range of 3 m from the bus stop address near the home address, it may be determined that the current geographic location is located in the target area.

A multimedia device is controlled to be turned on and the multimedia device is controlled to start playing the multimedia content in the step S103 when the current geographic location is located in the target area.

In an embodiment of the present disclosure, the multimedia device may refer to video playing application, music playing application, etc. in the terminal, and also may refer to video playing module, music playing module, etc. in the vehicle terminal.

In the step S103, the corresponding multimedia device may be controlled to be invoked, then the multimedia content to be played in the target area is selected in the multimedia device, and the multimedia content is played.

The multimedia device is controlled to be turned off in the step S104 when the current geographic location is located outside of the target area.

In the step S104, the exit from the multimedia device may be controlled, and the process of the multimedia device is ended.

Whether the current geographic location is located in the target area or not is detected by the present disclosure through configuring a target area and multimedia content to be played in the target area. The multimedia device can be controlled to be turned on and the multimedia device can be controlled to be started playing the multimedia content when the current geographic location is located in the target area, and the multimedia device can be controlled to be turned off when the current geographic location is located outside of the target area.

The method provided by the embodiment of the present disclosure can automatically start playing the multimedia content when the user reaches the target area, or automatically stop playing the multimedia content. It is simple and convenient to operate and use, and is capable of saving the time of the user, improving operational efficiency, and saving the energy.

In yet another embodiment of the present disclosure, the obtaining the target area in the step S101 includes the following steps.

In the step S201, a configured path is determined as the target area when the configured path configured by a user and containing at least one road segment is obtained.

In the step S201, since the user may configure a path from home to work unit, etc., this path typically includes at least one road segment which may refer to a transport line without junction nodes on the transport network, at this time, the whole road segment can be determined as the target area.

Or, in the step S202, a motion path configured by the user in an access application and containing at least one road segment is obtained, and the motion path is determined as the target area when the access application containing map information is accessed.

In the embodiment of the present disclosure, the access application containing map information may refer to map software, taxi-hailing app, etc., the access may refer to determining the motion path finally obtained by the access application as the target area.

In the step, the motion path obtained by the access application may be determined as the target area.

The configured path may be determined by the present disclosure as the target area when the configured path configured by the user and containing at least one road segment is obtained, or the motion path may be determined as a target area by obtaining the motion path configured by the user in an access application and containing at least one road segment when the access application containing map information is accessed.

The method provided by the embodiment of the present disclosure can automatically start playing the multimedia content when the user reaches the target area, or automatically stop playing the multimedia content, the playing of the multimedia content can be controlled only through presetting by the user. It is simple and convenient to operate, and is capable of saving the time of the user and saving the energy.

In the above embodiments, the configured path and the motion path contain at least one road segment therein, since the connection of every two road segments may be in the situations such as road, a junction of three roads, or crossroad, at this moment, if the user still watches the multimedia contents when walking, he will take risks and unnecessary loss. For this reason, in still another embodiment of the present disclosure, the method further includes the following steps.

In the step S301, whether the target area contains at least two road segments or not is judged.

In the embodiment of the present disclosure, since the user may pass a road segment or a plurality of road segments from one location to another location, in the step, the number of the road segments in the configured paths configured by the user may be calculated, or the number of the road segments in the motion path obtained by the access application may be calculated, and that whether the number of the road segments is more than two or not is judged.

In the step S302, whether a current geographic location is located within the preset range between any two road segments or not is detected when the target area contains at least two road segments.

In the embodiment of the present disclosure, the location between two road segments may be determined firstly, and then a preset range taking the location as its center is determined.

In the step S303, the multimedia device is controlled to pause the playing of the multimedia content when the current geographic location is located within the preset range between any two road segments.

when the target area contains at least two road segments, Whether the current geographic location is located within the preset range between any two road segments or not is detected in the present disclosure through judging whether the target area contains at least two road segments or not. The multimedia device may be controlled to pause the playing of the multimedia content when the current geographic location is located within the preset range between any two road segments.

With the method provided by the embodiment of the present disclosure, the user can pause the playing of the multimedia content when he moves from a segment of road to another segment of road without having to press the pause key in the screen manually. The method is simple and effective to operate, and avoids the occurrence of accidents such as car accidents caused by the distraction of the user due to watching multimedia content.

When the user configures a fixed geographic location, for example, home, frequently-visited coffee house etc., the user desires to automatically play the video when reaching this geographic location every time. For this purpose, in still another embodiment of the present disclosure, the method further includes the following steps.

In the step S401, a radius threshold value corresponding to a geographic location is obtained when the geographic location information of any one of geographic locations configured by a user is obtained.

In the embodiment of the present disclosure, since WIFI hotspots all have a certain coverage, the radius threshold value herein may be a coverage of the WIFI hotspots, etc.

In the step S402, the target area is determined to be an area with the geographic location as its center and the radius threshold value as its radius.

When the geographic position information of any one of the geographic positions configured by the user is obtained, the target area is determined to be an area with the geographic location as its center and the radius threshold value as its radius in the present disclosure through obtaining the radius threshold value corresponding to the geographic position.

A target area for playing multimedia content can be automatically determined by the method provided by the embodiments of the present disclosure through taking a geographic location as its center and taking the radius threshold value as its radius, and it is simple in operation and user-friendly.

In yet another embodiment of the present disclosure, the step S102 includes the following steps.

In the step S501, whether the operating state of a positioning module is an on-state or not is judged.

In the embodiments of the present disclosure, since the current location of a terminal needs to be detected, the positioning module in the terminal needs to be turned on firstly.

In the step S502, when the operating state of the positioning module is the on-state, the current geographic location is obtained.

In the step S503, whether the current geographic location is located within a boundary range of the target area or not is judged.

In the step S504, when the current geographic location is located within the boundary range of the target area, it is determined that the current geographic location is located in the target area.

By judging whether the operating state of the positioning module is the on-state or not, the current geographic location is obtained when the operating state of the positioning module is the on-state. Whether the current geographic location is located within the boundary range of the target area or not is judged, and when the current geographic location is located within the boundary range of the target area, it can be determined that the current geographic location is located in the target area.

The method provided by the embodiment of the present disclosure can automatically determine whether the terminal is located in the target area or not, and it is simple in operation and user-friendly.

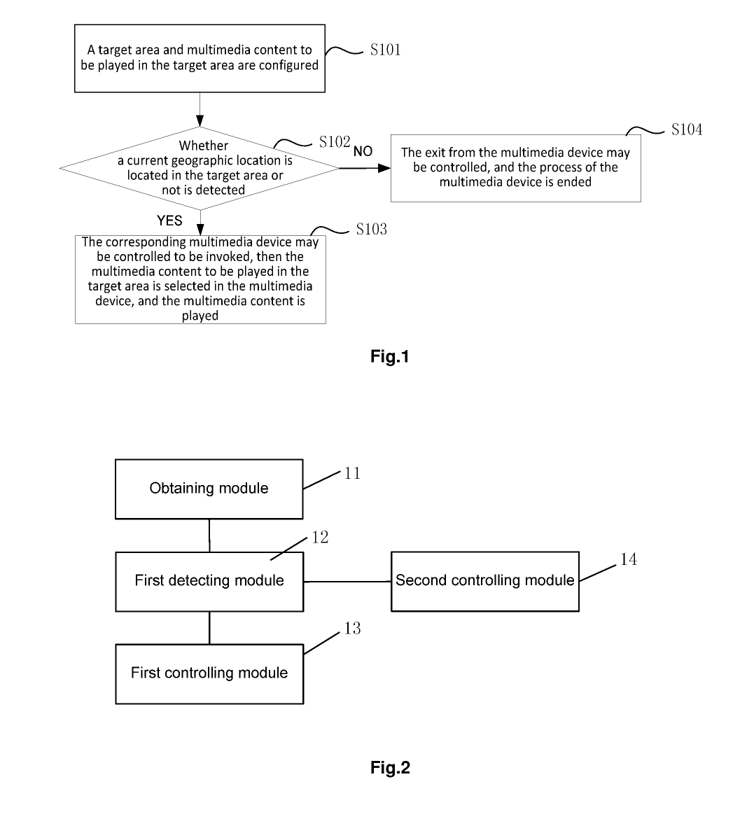

As shown in FIG. 2, in yet another embodiment of the present disclosure, a device for controlling multimedia is provided, including: an obtaining module 11, a first detecting module 12, a first controlling module 13 and a second controlling module 14.

The obtaining module 11 is configured to configure a target area and multimedia content to be played in the target area.

The first detecting module 12 is configured to detect whether a current geographic location is located in the target area or not.

The first controlling module 13 is configured to control the multimedia device to be turned on and control the multimedia device to start playing the multimedia content when the current geographic location is located in the target area.

The second controlling module 14 is configured to control the multimedia device to be turned off when the current geographic location is located outside of the target area.

In yet another embodiment of the present disclosure, the obtaining module 11 includes: a first determining submodule or a second determining submodule.

The first determining submodule is configured to determine a configured path as the target area when the configured path configured by a user and containing at least one road segment is obtained.

Or, the second determining submodule is configured to obtain a motion path configured by the user in an access application and containing at least one road segment and determine the motion path as the target area when the access application containing map information is accessed.

In yet another embodiment of the present disclosure, the device further includes: a judging module, a second detecting module and a third controlling module.

The judging module is configured to judge whether the target area contains at least two road segments or not.

The second detecting module is configured to detect whether the current geographic location is located within a preset range between any two road segments or not when the target area contains at least two road segments.

The third controlling module is configured to control the multimedia device to pause the playing of the multimedia content when the current geographic location is located within the preset range between any two road segments.

In yet another embodiment of the present disclosure, the obtaining module 11 further includes: a first obtaining submodule and a third determining submodule.

The first obtaining submodule is configured to obtain a radius threshold value corresponding to the geographic location when the geographic location information about any one of the geographic locations configured by the user is obtained.

The third determining submodule is configured to determine the target area to be an area with the geographic location as its center and the radius threshold value as its radius.

In yet another embodiment of the present disclosure, the first detecting module includes: a first judging submodule, a second obtaining submodule, a second judging submodule and a fourth determining submodule.

The first judging submodule is configured to judge whether the operating state of the positioning module is an on-state or not.

The second obtaining submodule is configured to obtain the current geographic location when the operating state of the positioning module is the on-state.

The second judging submodule is configured to judge whether the current geographic location is located within the boundary range of the target area or not.

The fourth determining submodule is configured to determine that the current geographic location is located in the target area when the current geographic location is located within the boundary range of the target area.

The embodiments of the present disclosure further provide a nonvolatile computer storage media, which stores computer-executable instructions for executing the method for controlling multimedia in any one of the method embodiments aforementioned of the present disclosure.

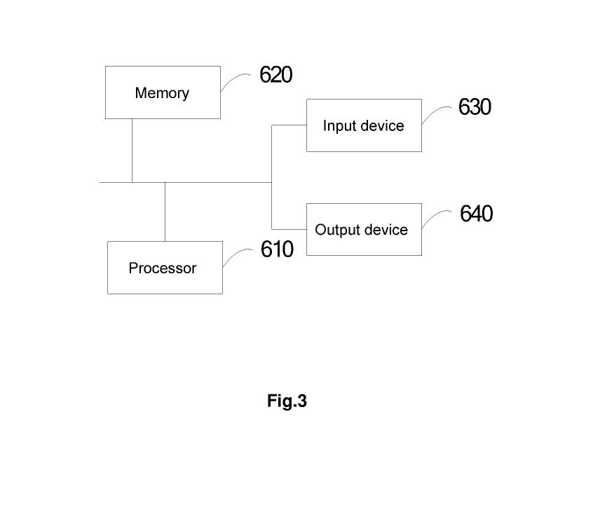

FIG. 3 is a diagram of the hardware configuration of the electronic device for executing the method for controlling multimedia provided by embodiments of the present disclosure. Referring to FIG. 3, the device includes:

one or more processors 610 and a memory 620. In FIG. 3, only one processor 610 is shown as an example.

The device for executing the method for controlling multimedia may further include: an input device 630 and an output device 640.

The processor 610, the memory 620, the input device 630 and the output device 640 may be connected by bus or other means. FIG. 3 shows the devices connected by bus as an example.

The memory 620 is a nonvolatile computer-readable storage media, which may be used to store nonvolatile software program, nonvolatile computer-executable program and module. The processor 610 may perform various functions and applications of the server and process data by running the nonvolatile software program, instructions and module stored in the memory 620, so as to realize the method for controlling multimedia of the examples aforementioned.

The memory 620 may include a program storage area and a data storage area, wherein the program storage area may store an operation system and an application program for achieving at least one function; the data storage area may store data established according to the use of the device for controlling multimedia and so on. In addition, the memory 620 may include a high-speed random access memory, and may further include a non-volatile memory, such as at least one of magnetic disk memory device, flash memory device or other non-volatile solid state memory device. In some examples, the memory 620 may alternatively include memories set remotely with respect to the processor 610, wherein these remote memories may be connected to the device for controlling multimedia via the network. The examples of the network include but are not limited to internet, intranet, local area network (LAN), mobile communication network and their combinations.

The input device 630 may receive the information of a number or a character as inputted, and generate key input signals relating to the user setting and function control of the device for controlling multimedia. The output device 640 may include a display device such as a display screen.

The one or more modules are stored in the memory 620. When the one or more modules are executed by one or more processors 610, the method for controlling multimedia according to any of the above examples are executed.

The above product may execute the method provided by the embodiments of the present disclosure, and has the corresponding functional module for executing the method, and therefore has beneficial effect. For the details that are not fully described in this embodiment, please refer to the methods provided by the embodiments of the present disclosure.

The electronic device of the embodiments of the present disclosure may be embodied in various forms, which include but are not limited to the following device.

(1) Mobile communication device, which is characterized by the mobile communication function, and the main objective of which is to provide voice communication and data communication. This kind of terminal includes: smart phone (e.g. iPhone), multimedia phone, feature phone and low-level phone etc.

(2) Ultra mobile personal computer device, which belongs to the range of personal computer, has the function of computing and processing and generally can also be used in mobile internet. This kind of terminal includes: PDA, MID and UMPC device etc., such as iPad.

(3) Portable entertainment device, which may display and play multimedia contents. This kind of device includes: audio and/or video player (e.g. iPod), hand-held game machine, electronic book device, smart toy and portable vehicle navigation device.

(4) Server, which is a device that provides computing service. The configuration of the server includes processor, hard disk, memory and system bus etc. The architecture of a server is similar to that of a general computer. However, the sever has a higher demanding with respect to the processing ability, stability, reliability, safety, expansibility and manageability etc, because the server is required to provide more reliable service.

(5) Other electronic device having function of data interaction.

The examples of the device have been described above for illustrative purposes only, wherein the units described as separated members may or may not be separated physically. The members shown as units may or may not be physical unit, that is, they may be located at one place, or may be distributed to a number of units in a network. The objective of the examples of the present disclosure may be achieved by selecting a part or all of the modules according to actual demand. The person skilled in the art may understand and implemente the present disclosure without creative efforts.

From the description of the above examples, the person skilled in the art may understand clearly that respective examples may be implemented by software in combination with a hardware platform, or by hardware only. Based on this understanding, the nature or the part contributory to the prior art of the technical solution as described above may be embodied in the form a computer software product, which may be stored in a computer-readable storage media, such as ROM/RAM, magnetic disk, optical disk etc., and may include a number of instructions for making a computer device (which may be a personal computer, a server or a network device etc.) execute the method according to the respective examples or a part of an example.

It should be noted that the examples as described above are only for the purpose of illustrating the solution of the present disclosure, without limiting the scope thereof. Although the present disclosure have been described according to the previous examples, the person skilled in the art will appreciate that various modifications to the solution recorded in the respective examples and equivalent substitutions for part of the features are possible, without departing from the scope and spirit of the present application as defined in the accompanying claims.

What is claimed is:

1. A method for controlling multimedia, comprising:
at an electronic device;
configuring a target area and multimedia content to be played in the target area;
detecting whether a current geographic location is located in the target area or not;
controlling a multimedia device to be turned on, and controlling a multimedia device to start playing the multimedia content when the current geographic location is located in the target area; and
controlling the multimedia device to be turned off when the current geographic location is located outside of the target area.

2. The method for controlling multimedia according to claim 1, wherein, the configuring the target area comprises:
determining a configured path as the target area when the configured path configured by a user and containing at least one road segment is obtained; or
obtaining a motion path configured by the user in an access application and containing at least one road segment, and determining the motion path as the target area when the access application containing map information is accessed.

3. The method for controlling multimedia according to claim 2, wherein, the method further comprises:
judging whether the target area contains at least two road segments or not;
detecting whether a current geographic location is located within a preset range between any two road segments or not when the target area contains at least two road segments; and
controlling the multimedia device to pause the playing of the multimedia content when the current geographic location is located within the preset range between any two road segments.

4. The method for controlling multimedia according to claim 1, wherein, the configuring the target area further comprises:
obtaining a radius threshold value corresponding to the geographic location when the geographic location information about any one of geographic location configured by the user is obtained; and
determining the target area to be an area with the geographic location as its center and the radius threshold value as its radius.

5. The method for controlling multimedia according to claim 1, wherein, the detecting whether the current geographic location is located in the target area or not comprises:
judging whether the operating state of a positioning module is an on-state or not,
obtaining the current geographic location when the operating state of the positioning module is the on-state,
judging whether the current geographic location is located within a boundary range of the target area or not; and
determining the current geographic location is located in the target area when the current geographic location is located within the boundary range of the target area.

6. A nonvolatile computer storage media, which stores computer-executable instructions, wherein the computer-executable instructions are configured to:
configure a target area and multimedia content to be played in the target area;
detect whether a current geographic location is located in the target area or not;
control a multimedia device to be turned on, and control a multimedia device to start playing the multimedia content when the current geographic location is located in the target area; and
control the multimedia device to be turned off when the current geographic location is located outside of the target area.

7. The nonvolatile computer storage media according to claim 6, wherein, the step to configure the target area comprises:
determining a configured path as the target area when the configured path configured by a user and containing at least one road segment is obtained; or
obtaining a motion path configured by the user in an access application and containing at least one road segment, and determining the motion path as the target area when the access application containing map information is accessed.

8. The nonvolatile computer storage media according to claim 7, wherein, the computer-executable instructions are further configured to:
judge whether the target area contains at least two road segments or not;
detect whether a current geographic location is located within a preset range between any two road segments or not when the target area contains at least two road segments; and
control the multimedia device to pause the playing of the multimedia content when the current geographic location is located within the preset range between any two road segments.

9. The nonvolatile computer storage media according to claim 6, wherein, the step to configure the target area further comprises:
obtaining a radius threshold value corresponding to the geographic location when the geographic location information about any one of geographic location configured by the user is obtained; and
determining the target area to be an area with the geographic location as its center and the radius threshold value as its radius.

10. The nonvolatile computer storage media according to claim 6, wherein, the step to detect whether the current geographic location is located in the target area or not comprises:
judging whether the operating state of a positioning module is an on-state or not,
obtaining the current geographic location when the operating state of the positioning module is the on-state,
judging whether the current geographic location is located within a boundary range of the target area or not; and
determining the current geographic location is located in the target area when the current geographic location is located within the boundary range of the target area.

11. An electronic device, comprising:
at least one processor; and
a memory which established a communication connection with the at least one processor;
wherein the memory stores instructions that are executable by the at least one processor, and the instructions are executed by the at least one processor so that the at least one processor is caused to:
configure a target area and multimedia content to be played in the target area;
detect whether a current geographic location is located in the target area or not;
control a multimedia device to be turned on, and control a multimedia device to start playing the multimedia content when the current geographic location is located in the target area; and
control the multimedia device to be turned off when the current geographic location is located outside of the target area.

12. The electronic device according to claim 11, wherein, the step to configure the target area comprises:
determining a configured path as the target area when the configured path configured by a user and containing at least one road segment is obtained; or
obtaining a motion path configured by the user in an access application and containing at least one road segment, and determining the motion path as the target area when the access application containing map information is accessed.

13. The electronic device according to claim 12, wherein, the at least one processor is further caused to:
judge whether the target area contains at least two road segments or not;
detect whether the current geographic location is located within a preset range between any two road segments or not when the target area contains at least two road segments; and
control the multimedia device to pause the playing of the multimedia content when the current geographic location is located within the preset range between any two road segments.

14. The electronic device according to claim 11, wherein, the step to configure the target area further comprises:
obtaining a radius threshold value corresponding to the geographic location when the geographic location information about any one of geographic location configured by the user is obtained; and
determining the target area to be an area with the geographic location as its center and the radius threshold value as its radius.

15. The electronic device according to claim 11, wherein, the step to detect whether the current geographic location is located in the target area or not comprises:
judging whether the operating state of a positioning module is an on-state or not,
obtaining the current geographic location when the operating state of the positioning module is the on-state,
judging whether the current geographic location is located within a boundary range of the target area or not; and
determining the current geographic location is located in the target area when the current geographic location is located within the boundary range of the target area.
